(19) United States
(12) Patent Application Publication
(10) Pub. No.: US 2006/0251899 A1
(43) Pub. Date: Nov. 9, 2006

(54) Process for manufacturing a multilayer article possessing a protective layer

(76) Inventors: Wen P. Liao, Clifton Park, NY (US); Sean Armstrong, East Greenbush, NY (US)

Correspondence Address: DILWORTH & BARRESE, LLP, 333 EARLE OVINGTON BLVD., UNIONDALE, NY, 11553, US

(21) Appl. No.: 11/298,352

(22) Filed: Dec. 9, 2005

Related U.S. Application Data
(60) Provisional application No. 60/678,992, filed on May 9, 2005.

(51) Int. Cl. B32B 37/00

(52) U.S. Cl. 428/411.1; 156/289

(57) ABSTRACT

A process is provided for fabricating a multilayer article possessing a protective layer which comprises: a) applying a curable protective layer-forming composition to the release coating side of a release liner; b) curing the curable protective layer-forming composition on the release liner; c) forming a plurality of release elements from the structure resulting from step (b), each release element possessing a cured protective layer releasably adhered on one side thereof to the release coating side of the release liner, the other side of the cured protective layer being exposed; d) applying the exposed side of the cured protective layer of a release element to a substrate layer with a quantity of curable adhesive disposed therebetween to provide a curable multilayer article; e) curing the curable multilayer article to adhesively bond the protective layer of its release element to its substrate layer; and, f) separating the cured multilayer article from its release liner to provide a multilayer article possessing a protective layer bonded to a substrate layer. The foregoing process is especially adapted for the manufacture of a high capacity optical information storage medium, in particular, a Blu-ray Disc.

### CROSS REFERENCE TO RELATED APPLICATION

This application claims the benefit of U.S. provisional application Ser. No. 60/678,992, filed May 9, 2005, the entire contents of which are incorporated by reference herein.

### BACKGROUND OF THE INVENTION

This invention relates to a process for the manufacture of a multiplayer article, or laminate, possessing a protective layer bonded to a substrate layer and, in particular, to a high capacity optical information storage medium such as a Blu-ray Disc.

A new form of high capacity optical information storage medium, the so-called “Blu-ray” Disc (BD), has only recently made its commercial appearance. The Blu-ray Disc format is intended to replace videotape and current digital versatile disc (DVD) technology and is likely to become a standard for computer data storage, high-definition movies and video games.

At present, a Blu-ray Disc (BD) consists of a 1.1 mm substrate layer that is sputtered on one side with a metal or metal alloy as a reflective layer, a thin information layer (for BD-ROM), a recordable layer (for BD-R) or a re-recordable layer (for BD-RE) and, finally, a 100 micron protective topcoat, or cover, layer. The cover layer consists of a relatively expensive solvent-casted polycarbonate (PC) film of approximately 100 microns thickness bonded via an adhesive to the information layer, recordable layer or re-recordable layer, as the case may be, of the substrate. Because this PC film readily scratches and acquires fingerprints, the current commercial version of the Blu-ray Disc is enclosed within a protective cartridge, a component that adds significantly to the cost of the product. The information, recordable or re-recordable layer of a Blu-ray disc is only about 100 microns below its surface therefore thus requiring increased surface integrity compared to that which is acceptable for a conventional compact disc (CD) or digital versatile disc (DVD) surface.

Efforts are currently being made to replace the protective cartridge of a Blu-ray Disc with a protective coating on the disc and even to replacing the PC film used as the cover layer with a lower cost but still effective substitute. PC film is not only an expensive material, it is difficult to assemble in the disc manufacturing process. One approach being considered to improve the current Blu-ray Disc consists of a two-layer spincoatable system wherein a first 94-98 micron layer is spun onto the information-containing 1.1 mm substrate layer followed by a second 2-6 micron protective hardcoat layer which provides abrasion resistance and anti-fingerprint properties. Also being considered is a single 100 mm layer spincoatable system which would combine the aforementioned two coating operations into a single coating step employing a single coating composition that effectively combines all of the functions of the two-coat system.

Whether a two-coat or a single coat protective layer approach is ultimately adopted, fabricating the 100 micron cover layer (hardcoat) for a Blu-ray Disc requires new materials, manufacturing methods and equipment. These requirements, particularly for new processes and equipment, and the high investment costs associated with their development have been an obstacle to the wider adoption of the Blu-ray Disc format.

A process in which existing equipment for CD and DVD fabrication can be utilized would have the effect of accelerating the commercial adoption of the Blu-ray format.

Currently, the cover layer of a Blu-ray disc is prepared by one of two methods. In one method, a 100 micron polycarbonate film cover layer is bonded to the 1.1 mm thermoplastic substrate using an ultraviolet light (UV)-cured adhesive. In the second method, a 100 micron cover layer is spincoated onto the 1.1 mm thermoplastic substrate followed by UV curing.

### BRIEF DESCRIPTION OF THE INVENTION

In accordance with the present invention, there is provided a process for fabricating a multilayer article possessing a protective layer which comprises:

a) applying a curable protective layer-forming composition to the release coating side of a release liner;

b) curing the curable protective layer-forming composition on the release liner;

c) forming a plurality of release elements from the structure resulting from step (b), each release element possessing a cured protective layer releasably adhered on one side thereof to the release coating side of the release liner, the other side of the cured protective layer being exposed;

d) applying the exposed side of the cured protective layer of a release element to a substrate layer with a quantity of curable adhesive disposed therebetween to provide a curable multilayer article;

e) curing the curable multilayer article to adhesively bond the protective layer of its release element to its substrate layer; and,

f) separating the cured multilayer article from its release liner to provide a multilayer article possessing a protective layer bonded to a substrate layer.

The foregoing process when applied to the manufacture of a Blu-ray Disc utilizes existing equipment, materials and procedures in a novel manner to provide the disc at significantly reduced cost.

The term “curable protective layer” shall be understood herein to mean a layer of composition containing at least one curable monomer, the layer following curing providing protection to at least one side of a substrate layer to which it is adhesively bonded.

The term “substrate layer” shall be understood herein to mean a preformed layer, made up of a single layer or assembly of individual layers, to at least one side of which a protective layer will be applied.

The term “curable” shall be understood herein to mean the full or partial curing of a composition comprising one or more curable monomers, e.g., to at least the “green” strength of the composition, the curing being achieved by any suitable means, e.g., thermal curing, curing with UV, E-beam, etc., in accordance with known and conventional procedures.

### DESCRIPTION OF THE INVENTION

The process of the invention will hereinafter be described in connection with the fabrication of a high capacity optical information storage disc (“optical disc”), in particular, a Blu-ray Disc (BD), in which the protective layer of the disc shall be referred to as the “cover layer”. The process for the fabrication of the optical disc includes at least the following operations:

a) applying a curable cover layer-forming composition to the release coating side of a release liner;

b) curing the curable cover layer-forming composition on the release liner;

c) forming a plurality of release discs from the structure resulting from step (b), each release disc possessing a cover layer releasably adhered on one side thereof to the release coating side of the release liner, the other side of the cover layer being exposed;

d) applying the exposed side of the cover layer of a release disc to the reflective side of a preformed thermoplastic substrate disc with a quantity of curable bonding adhesive disposed therebetween to provide a curable disc assembly;

e) curing the curable disc assembly to bond the release disc to the thermoplastic substrate; and,

f) separating the release disc with the thermoplastic substrate disc bonded thereto from the release liner to provide the optical disc.

A. The Release Liner

The process of the invention utilizes a release liner, i.e., a flexible sheet or film possessing a release coating, or layer, as a temporary surface upon which to form the protective cover layer component of the optical disc. The release liner is obtained by applying a release coating to one side of a suitable liner, e.g., a polyester sheet or film having a thickness of from about 0.01 to about 0.6 mm and a width which is in excess of the diameter of the disc-shaped optical information storage unit, e.g., 120 mm in the case of a BD.

In one embodiment, the release coating can be obtained by applying a curable release coating-forming composition to the liner, e.g., a UV-curable silicone epoxide and a photo initiator dissolved in a suitable solvent, and thereafter curing the composition by exposure to UV light.

When the curable adhesive which is later used in the process to bond the cover layer to the thermoplastic substrate is UV-curable, it is necessary that the liner material be transparent to UV light to permit transmission of the UV radiation therethrough.

Advantageously, the process of the invention will be a continuous or semi-continuous one and as such will employ a continuously or intermittently moving strip of release liner upon which are carried out at predetermined intervals along its length the sequential operations of applying a curable cover layer-forming composition to the release liner, curing the cover layer-forming composition to provide a cured cover layer and forming a plurality of release discs from the cover layer-release liner temporary assembly.

B. The Cover Layer

The cover layer component of the optical information storage medium is formed on the entire side of the release liner possessing the release layer. The cover layer is applied, either all at once or in several applications, to the release liner as one or more curable liquid compositions so as to provide, following curing, a layer of suitable thickness, e.g., in a first embodiment from about 0.1 to about 100 microns thickness and in a second embodiment from about 0.01 to about 10 microns thickness.

In one embodiment, the curable composition is applied by a roll coating process. Gravure coating, immersion (dip) coating and curtain coating are all suitable roll coating operations that can be utilized herein.

When the cover layer is built up from several applications of curable cover layer-forming composition, the composition of an individual application can be identical to or different from the other(s). Any of the known and conventional curable compositions heretofore used for providing the protective cover layer component of an optical disc can be utilized herein.

In one embodiment, the curable cover layer-forming composition includes at least one functionalized colloidal silica, at least one polymerizable monomer and at least one curing agent. When exposed to curing conditions, e.g., UV radiation, in accordance with known procedures, the resulting cured composition provides a dimensionally stable, scratch and abrasion resistant protective cover layer for the high capacity optical information storage disc herein.

C. The Release Disc

Following the curing of the cover layer-forming composition on the release liner, a plurality of disc-shaped units are obtained therefrom by any suitable operation, e.g., by die-cutting or stamping. Discs of standard size will typically have an outer diameter of about 120 mm, an inner diameter of 15 mm and a thickness which is the sum of the individual thicknesses of protective its cover layer and associated release liner. The disc-shaped units, now referred to as release discs, thus are made up of a cured cover layer releasably adhered to the release-layer side of a temporary release liner.

The release discs are now ready to be bonded to the thermoplastic substrate component which, once accomplished, will result in a fully assembled high storage capacity optical information medium.

D. The Thermoplastic Substrate

In one embodiment of the process of the present invention, release discs obtained in the manner described above are supplied to one side of a conventional DVD fabrication line in place of one of the injection molders normally associated therewith. In this stage of the manufacturing process, a release disc will be permanently bonded to a preformed thermoplastic substrate employing known and conventional procedures.

Briefly described, the process of bonding the thermoplastic substrate to a release disc consists of dispensing a quantity of curable adhesive onto the inner diameter of the reflective side of an identically dimensioned preformed thermoplastic substrate disc and thereafter placing the release disc thereon. The “reflective side” of the preformed thermoplastic substrate disc shall be understood herein to mean that side of the substrate upon which a reflective coating, e.g., aluminum or silver alloy, has been applied in accordance with know and conventional procedures.

A slight amount of force may be used to push the release disc into wider contact with the adhesive on the thermoplastic substrate disc. This assembly is then spun in order to force the interposed adhesive to the outer diameter of the disc “sandwich”. The assembly is then subjected to curing conditions, e.g., UV light, in order to permanently bond the release disc to the thermoplastic substrate via the cured adhesive disposed therebetween. Typical dimensions for the completed disc structure are as follows: 1.1 mm for the thermoplastic substrate (including information layer)/adhesive layer/release-disc. The total thickness of the adhesive layer and the release disc minus the thickness of the release liner is typically about 100 microns. In order to use the disc, the release liner component is separated therefrom, e.g., by being peeled away, from the bonded disc assembly, the resulting completed unit possessing a 1.1 mm substrate and a 100 micron cover layer.

It is, of course, contemplated that each of the operations described above, from the manufacture of the release liner to the final assembly of the optical disc unit and any optional operation(s), will be accomplished employing automated high speed machinery to which the process of the invention is particularly well suited.

The following example is illustrative of the process of the invention as applied to the manufacture of an optical disc.

### EXAMPLE

Tilt was measured using a Dr. Schenk PROmeteus MT-146/Blu-ray instrument.

A. Preparation of the UV-Curable Cover Layer-Forming Composition

To a 2 liter, 4-neck flask equipped with a thermometer, a condenser, an addition funnel, and an overhead stirrer was charged 300 g aqueous colloidal silica (Nalco 1034A from Nalco) containing 34 wt. % SiO₂ in water, 300 g methoxypropanol, and 5.1 g phenyl trimethoxysilane, a functionalizing agent for the colloidal silica. The mixture was heated to 80° C. under nitrogen for two hours. An aliquot of 0.5 g of triethylamine was added and the mixing continued at 80° C. for another one hour. While a total of 360 g of methoxypropanol was continuously added to the batch, the mixture was heated to distill water off until the batch temperature reached 110° C. The batch was cooled to 90° C. and 0.5 g trimethylamine and 15 g hexamethyltrisilazane (a capping agent for residual hydroxyl groups on the surface of the colloidal silica) were added. The batch was subsequently heated back to reflux at 110° C. for one hour. Slight vacuum was applied to distill off about 50 g of solvent. The batch, now containing functionalized and capped colloidal silica, was cooled to 40° C. and combined with 67.3 g of the epoxy resin, 3,4-epoxy-cyclohexylmethy-3,4-epoxycyclohexanecarboxylate (Cyracure™ UVR6105 from Dow Chemical). After the epoxy resin was completely dissolved, vacuum was applied to distill off solvents. The batch was gradually heated up to 100° C. at full vacuum of 13 mm Hg and maintained under these conditions for 30 minutes to completely remove volatiles. After the volatiles were removed, the batch temperature was lowered to 60° C. and 77.8 g 3-ethyl-3-hydroxymethyloxetane (Cyracure UVR6000 from Dow Chemnicals) and 16.9 g Joncryl 587AC (an acrylate polyol in acetone at 50% actives from Johnson Polymers) were charged to the batch. Acetone was removed by vacuum after the Joncryl 587AC was completely dissolved. The batch was further cooled to 40° C. and catalyzed by mixing with 3.0 g Irgacure® 250 (from Ciba Specialty Chemicals) and 15.0 g premixed 10% Iracure® 2959 (from Ciba Specialty Chemicals) in Cyracure™ UVR6105.

B. Preparation of the UV-Curable Release-Forming Composition

UV-curable release-forming composition was prepared by mixing 100 parts of UV9315, a UV-curable silicone epoxide from GE Advanced Materials—Silicone, with 2.5 parts UV9390C, an iodonium photoinitiator from GE Advanced Materials. The resin was then dissolved in a solvent mixture containing 9 parts hexane to 1 part of acetone at 20% (w/w) concentration.

C. Preparation of the UV-Curable Bonding Adhesive

The UV-curable bonding adhesive was prepared by mixing 78.6 parts of polyester resin Genomer 6083 HD from RahnUSA Corp., 17.3 parts of hexanediol diacrylate, and 4.1 parts of Darocure 1173 (a radical photoinitiator from Ciba Specialty Chemicals) until complete dissolution.

D. Fabrication of the Release Disc

A release liner was prepared by coating a transparent polyester liner (5 mil thick) with the UV-curable release-forming solution described above at about 100 microns thickness. The coating was fully cured with Fusion UV equipped with H bulbs at an intensity of 1.5 W/cm² and a total dosage of 1 J/cm². The UV-curable cover layer-forming composition described above was subsequently applied the release liner using a #48 wire wound rode. The coating was cured with Fusion UV equipped with H bulbs at an intensity of 1.5 W/cm² and a total dosage of 3 J/cm². A release-disc with an outer diameter of 120 mm and an inner diameter of 15 mm was stamped from the cover layer-coated release liner.

A completed disc was assembled by bonding the release disc to a preformed disc-shaped thermoplastic substrate. This operation consisted of dispensing the UV-curable bonding adhesive described above onto the inner diameter of the disc-shaped substrate (GE Noryl®: blend of polyphenylene oxide (PPO) and polystyrene (PS)) having a diameter of 120 mm and a thickness of 1.1 mm and then placing the release-disc thereon in registry with the substrate disc. A slight amount of force was used to push the release-disc into wider contact with the adhesive. The entire assembly was then spun in order to force the adhesive to the outer diameter of this assembly. The adhesive was cured by UV light passing through the polyester release liner at an intensity of 1.5 W/cm² and a total dosage of 3 J/cm². The release liner was easily peeled off without damaging the underlining protective cover layer. Following the removal of the release liner, the filly assembled high storage capacity information storage disc measured an average radial deviation of −0.11°.

While the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

What is claimed is:

1. A process for fabricating a multilayer article possessing a protective layer which comprises:
a) applying a curable protective layer-forming composition to the release coating side of a release liner;
b) curing the curable protective layer-forming composition on the release liner;
c) forming a plurality of release elements from the structure resulting from step (b), each release element possessing a cured protective layer releasably adhered on one side thereof to the release coating side of the release liner, the other side of the cured protective layer being exposed;
d) applying the exposed side of the cured protective layer of a release element to a substrate layer with a quantity of curable adhesive disposed therebetween to provide a curable multilayer article;
e) curing the curable multilayer article to adhesively bond the protective layer of its release element to its substrate layer; and,
f) separating the cured multilayer article from its release liner to provide a multilayer article possessing a protective layer bonded to a substrate layer.

2. The process of claim 1 wherein the curable protective layer-forming composition contains at least one thermally curable monomer, at least one UV-curable monomer or mixture of at least one thermally curable monomer and at least one UV-curable monomer and, optionally, functionalized colloidal silica.

3. The process of claim 1 wherein the curable protective layer-forming composition contains at least one UV-curable monomer and, optionally, functionalized colloidal silica, and the release liner is transparent to UV light.

4. The process of claim 1 wherein the release elements are stamped or die-cut from the structure of step (b).

5. The process of claim 4 wherein the release elements are disc-shaped.

6. The process of claim 1 wherein the substrate layer of step (d) is fabricated from a thermoplastic resin.

7. The process of claim 5 wherein the substrate layer of step (d) is fabricated from a thermoplastic resin, the substrate layer being disc-shaped and having a diameter substantially the same as the diameter of a release element.

8. The process of claim 1 wherein the release liner of step (a) is obtained by applying a curable release layer-forming composition to a liner and thereafter subjecting the release layer-forming composition to curing conditions.

9. The process of claim 8 wherein the release layer-forming composition is thermally curable and/or UV-curable.

10. The process of claim 8 wherein the release layer-forming composition is UV-curable and the liner is a UV-transparent sheet.

11. The process of claim 10 wherein the sheet is a flexible polyester sheet.

12. The process of claim 1 wherein the curable protective layer-forming composition is applied to the release liner by a roll coating operation.

13. The process of claim 12 wherein the roll coating operation is one of gravure coating, immersion coating and curtain coating.

14. The process of claim 1 wherein the protective layer is built up from at least two successively applied and cured layers of the same or differing composition.

15. A structure comprising:
a) a layer of curable hardcoat-forming composition; and,
b) a release liner having a release layer on at least one side of a liner, the layer of curable hardcoat-forming composition, following the curing thereof, being releasably adhered to the release layer side of the release liner.

16. The structure of claim 15 wherein the release layer of the release liner is obtained by applying a curable release-forming composition to a side of the liner and thereafter subjecting the release layer-forming composition to curing conditions.

17. The structure of claim 16 wherein the release layer-forming composition is thermally curable and/or UV-curable.

18. The structure of claim 15 wherein the layer of curable hardcoat-forming composition is thermally curable and/or UV-curable.

19. The structure of claim 15 wherein the layer of curable hardcoat-forming composition is UV-curable and the release liner is transparent to UV light.

20. The structure of claim 15 wherein the layer of curable hardcoat-forming composition exhibits following the curing thereof, scratch and abrasion resistance and/or antifingerprint properties.

21. A process for the fabrication of an optical disc possessing a protective layer which comprises:
a) applying a curable cover layer-forming composition to the release coating side of a release liner;
b) curing the curable cover layer-forming composition on the release liner;
c) forming a plurality of release discs from the structure resulting from step (b), each release disc possessing a cover layer releasably adhered on one side thereof to the release coating side of the release liner, the other side of the cover layer being exposed;
d) applying the exposed side of the cover layer of a release disc to the reflective side of a preformed thermoplastic substrate disc with a quantity of curable bonding adhesive disposed therebetween to provide a curable disc assembly;
e) curing the curable disc assembly to bond the release disc to the thermoplastic substrate; and,
f) separating the release disc with the thermoplastic substrate disc bonded thereto from the release liner to provide the optical disc.

22. The process of claim 21 wherein the preformed thermoplastic substrate disc possesses an outside diameter of from about 1 to about 50 cm and a thickness of from about 0.1 to about 5 mm.

23. The process of claim 21 wherein the preformed thermoplastic substrate disc possesses an outside diameter of from about 3 to about 15 cm and a thickness of from about 0.9 to about 1.3 mm.

24. The process of claim 1 wherein the optical disc is a Blue-ray Disc.

25. The process of claim 24 wherein the thickness of the cover layer is from about 0.1 to about 100 microns.
